(19) United States
(12) Patent Application Publication
(10) Pub. No.: US 2010/0210126 A1
(43) Pub. Date: Aug. 19, 2010

(54) DUAL SOURCE CONNECTOR SYSTEM

(76) Inventor: Joseph McNeill Everett, Cary, NC (US)

Correspondence Address: PASSE' INTELLECTUAL PROPERTY, LLC, 1717 BRASSFIELD RD., RALEIGH, NC, 27614, US

(21) Appl. No.: 12/682,472

(22) PCT Filed: Oct. 9, 2008
(86) PCT No.: PCT/US08/79323

§ 371 Date: Apr. 9, 2010

Related U.S. Application Data
(60) Provisional application No. 60/960,745, filed on Oct. 11, 2007.

(51) Int. Cl. H01R 13/44

(52) U.S. Cl. 439/145

(57) ABSTRACT

The present invention relates to a device for attaching a temporary and a permanent generator as a backup to a cellular tower or to other electrically supported device. The device of the invention provides a means for only allowing one generator at a time to be attached.

This application claims priority of the U.S. Application Ser. No. 60/960,745 filed Oct. 11, 2007 and incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to power systems for large-scale electrical loads particularly to a dual-source connector system that provides for alternate connection of two different electrical power sources to the same load.

2. Description of Related Art

Early cellular towers typically included manual transfer switches for connection to portable generators to provide emergency backup power. However, once permanent generators became commonplace in the construction of cellular sites, automatic transfer switches were provided for the automatic switching to the backup power provided by the permanent generator. Since the original tower power systems were adapted to the newly installed permanent generators, the manual transfer switches were typically left intact and connected in series to the new automatic transfer switches.

Maintenance crews and the like have come to expect the presence of both the manual transfer switch and the automatic transfer switch, so that a portable generator may still be connected to the manual transfer switch in emergency situations. However, in the construction of new cellular towers, the original manual transfer switches have typically been replaced with a single automatic transfer switch for connection to the permanent generator. Thus, in emergencies, when the permanent generator is not available to produce power, a connection to a portable generator is no longer possible. Accordingly, it would be useful to provide a system that would solve this type of issue, whether in a cell phone tower situation or any other situation utilizing a backup generator, for example residence, hospital, government, manufacturing, commercial establishment and the like.

### BRIEF SUMMARY OF THE INVENTION

The present invention relates to the discovery that a dual source connector system provides a solution to the above described problems by providing a device which allows the automatic connection of a permanent generator, while also allowing the use of a manually operated generator using the same installed control device. Further, it can do this in a safe manner and yet be available in the event of an emergency situation requiring a temporary generator.

In one embodiment of the present invention there is disclosed a dual electrical source connector system comprising:
a) a housing having an open front, wherein the housing defines an open interior area and has a first interior region and a second interior region;
b) a first set of electrical source connectors positioned within the first region;
c) a second set of electrical source connectors positioned within the second region;
d) one or more blocking devices which physically allows no more than one set of electrical source connectors to be connected to an electrical source at a time.

### BRIEF DESCRIPTION OF THE DRAWINGS

FIG. 1 is a block diagram of a dual electrical source connector system of the present invention used in controlling power to a cell tower.

FIG. 2 is an environmental, perspective view of a dual electrical source connector system, configured for a connection to a permanent backup generator.

FIG. 3 is an environmental, perspective view of a dual electrical source connector system, configured for a connection to a portable generator.

FIG. 4 is an exploded perspective view of a dual electrical source connector system of the present invention.

FIG. 5 is a perspective view of an alternate embodiment of the present invention showing the permanent generator connection.

FIG. 6 is a perspective view of an alternate embodiment of the present invention showing the temporary generator connection.

FIG. 7 is a back perspective view of the alternate embodiment of the present invention.

Note that similar reference numbers and characters denote corresponding features throughout the attached drawings.

### DETAILED DESCRIPTION OF THE INVENTION

While this invention is susceptible to embodiment in many different forms, there is shown in the drawings and will herein be described in detailed specific embodiments, with the understanding that the present disclosure of such embodiments is to be considered as an example of the principles and not intended to limit the invention to the specific embodiments shown and described. In the description below, like reference numerals are used to describe the same, similar or corresponding parts in several views of the drawings. This detailed description defines the meaning of the terms used herein, and specifically describes embodiments in order for those skilled in the art to practice the invention.

The terms “a” or “an,” as used herein, are defined as one, or as more than one. The term “plurality,” as used herein, is defined as two or as more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Reference throughout this document to “one embodiment,” “certain embodiments,” “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments, without limitation.

The term “or” as used herein is to be interpreted as all inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these, or their equivalent in view of the disclosure herein and use of the term “means,” is not intended to be limiting.

As used herein the term “dual electrical source connector system” refers to a device for connecting two electrical powers sources to an automatic cutoff switch for those conditions when power from a power grid is not available. For example, as suggested above, an automatic transfer switch could switch to a permanent generator when the power grid power is not available. However, if the permanent generator is not operating, needs repair, needs replacing or the like the device allows for a second temporary generator device to be attached to provide power. Because only one power source should be providing power, only one device can be active at a time. Rather than a switching device between each of the power sources, the present device only allows that one electrical source be connected to the system at a time. In normal operation, a permanent generator will be unplugged from one part of the invention system, and the temporary generator connected to a different part of the system in a manual manner.

As used herein, “housing” means a container for housing the connectors for the permanent and temporary generators or other electrical connectors. The container can be made of any suitable material such as plastic or metal, and is constructed in a manner that the elements are essentially kept out when the housing is placed in an open area. The housing is constructed in a manner that it is enclosed on all sides with doors or panels to provide access to the connectors. One embodiment has a front panel for access to the connectors and another embodiment has a panel on a bottom side of the housing to run cables to a set of the connectors, and provide rain protection at the same time. The doors or panels can include a front place for rain doors, a sliding door and the like as further described herein. The housing has access to allow wiring of the permanent generator and front access to the connectors that disconnect the permanent generator and connect the temporary generator. The housing defines an interior area and that area has at a minimum a first interior region and a second interior region.

As used herein, an “automatic transfer switch” refers to an auto switch that is connected to an electrical source grid from a utility or the like. In the event that the power being received from the power grid and being used by a cell tower or any other establishment is interrupted, such as by storms, repair work and the like, the auto transfer switch can transfer the load from the power grid to an attached electrical power generator. The present invention system allows a permanent generator to be attached to the transfer switch but in the event the generator is broken or otherwise needs to be removed from the auto switch, a second temporary generator can be attached to the system quickly and easily by removing the pigtail connectors, and attaching the second generator cables to the second set of connectors. Disconnection of the temporary generator is by reversing the process and is likewise simple.

The dual electrical source connector system provides a first and second set of connectors for selectively connecting one of two electrical sources to an electrical load. In one embodiment the first electrical source is a permanent generator and the second electrical source is a temporary electrical generator. Each set of connectors is mounted within its own region within the housing. So, the first set of electrical source connectors is positioned within the first region and the second set of electrical source connectors is positioned within the second region.

The connectors can be mounted within the region in any convenient means, either in rows, columns, bunches or the like and are connected directly or indirectly (through an auto disconnect for example), to the same supply terminals of a load. There is also a blocking device which physically allows only one set of electrical source connectors to be connected to an electrical source at a time. This can be done in any manner but in one embodiment, there is a sliding panel disposed in the housing, which moves between a first position and a second position such that in each position only one of the set of connectors can be accessed. This can be done merely as a cover or be designed to be so close to the connectors, that anything plugged into the connectors must be removed in order to move the sliding panel in place. With this blocking device only one device can be used at a time and the permanent generator must be disconnected from the system, before a temporary generator could be connected to the second set of connectors.

In one embodiment then of the present invention a dual electrical source connector system is configured to alternately permit the connection of a permanent standby generator, to one set of connectors and a portable backup generator to the other set of connectors, to power a cellular telephone tower or other installation or establishment having a standby generator provided with an automatic transfer switch. In one embodiment the housing has laterally opposed the first and second regions for positioning the first and second set of connectors.

In one embodiment the first set of electrical source connectors includes a first pair of male connectors adapted to be electrically connected to an automatic transfer switch and for connecting the phase terminals of the portable generator to the connectors and thus to the switch, and a second pair of male connectors for connecting neutral and ground wires from the portable generator to the neutral and ground buses which can be attached in the housing. Likewise the second set of electrical source connectors includes a pair of male connectors adapted to be electrically connected to an automatic transfer switch. The interior region would have a pair of connectors below the male connectors so that one end of a pair of cables pass for attachment to the phase terminals of a permanent standby generator by pigtail leads. The permanent generator is then installed permanently to the system and disconnected by removal of the pigtail leads. The pigtail leads have connectors to attach to the male connectors and thus to the automatic switch.

Male and female connectors are standard, but in one embodiment, different connectors are used in the first and second regions so that the portable generator is not accidently attached to the permanent generator. In practice, a power grid is attached to an auto transfer switch. In the case of the power grid failing, the auto transfer switch disconnects the grid and moves over to a second connection. The switch is connected to the dual electrical source connector. Under normal operation the permanent generator is connected to the connector and when the auto transfer switch is activated the permanent generator is turned on and provides power through the transfer switch instead of from the electrical power grid. However, in the case where the generator is not operational for whatever reason, a second generator is connected to the second set of connectors and the permanent generator disconnected merely by removing the pigtail leads.

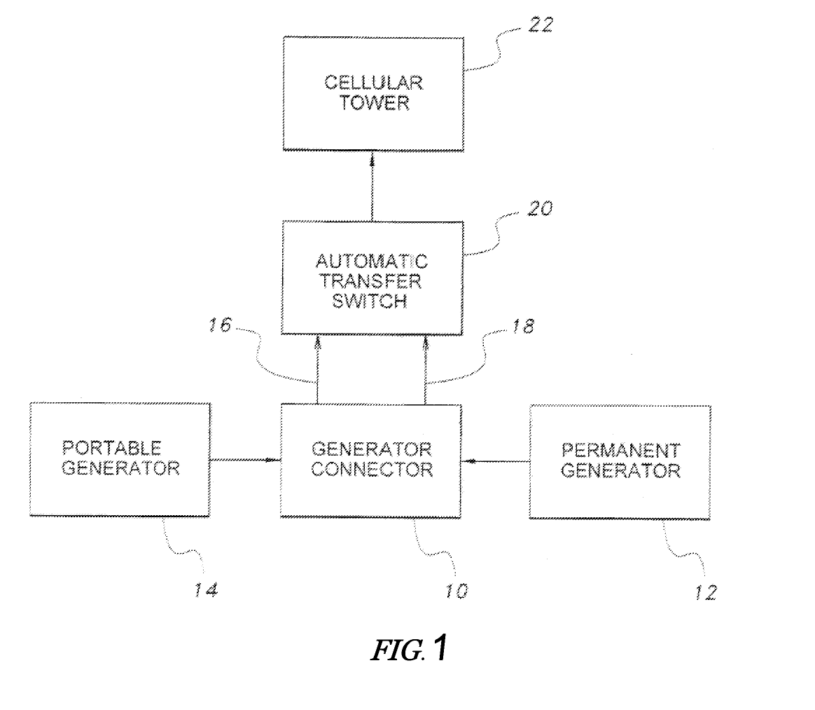

Now referring to the drawings, FIG. 1 is a schematic of an embodiment of the present invention. In this schematic, a dual source connector system 10 provides a first and second set of connectors for selectively connecting both a permanent and temporary 14, permanent 12 backup generator, to connect to an automatic transfer switch 20 associated with an electrical load, such as the exemplary cell tower 22. The cell tower 22 is, of course, a particular embodiment of the present invention and backup of other systems is contemplated within the scope of the disclosure. Also, noted is that the system 10 can be used with essentially any electrical load, but many embodiments deal with the load from the electrical utility. As discussed above, under normal conditions the primary or permanent generator 12 provides all the emergency or backup power to a cellular tower 22 via pathway 18. However, if a situation where the permanent generator 12 is damaged or otherwise rendered incapable of providing backup power, the dual source connector system 10 allows a portable generator 14 to feed power through the automatic transfer switch 20 via path 16 to supply an electrical load to the cellular tower 22. The ungrounded conductors are the same in path 16 as in path 18. Path 18 does not include a neutral or ground conductor.

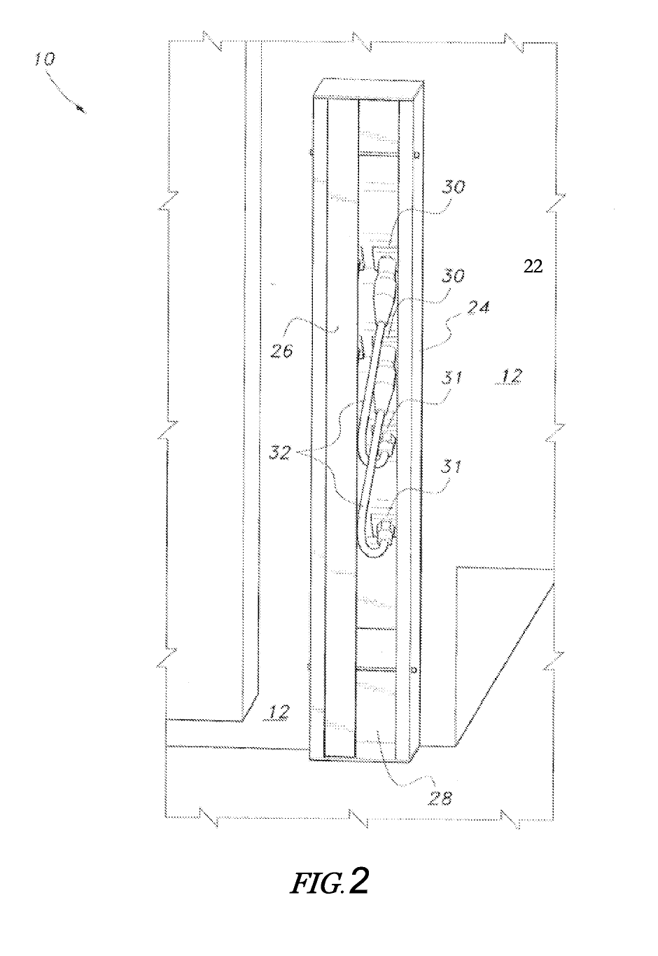

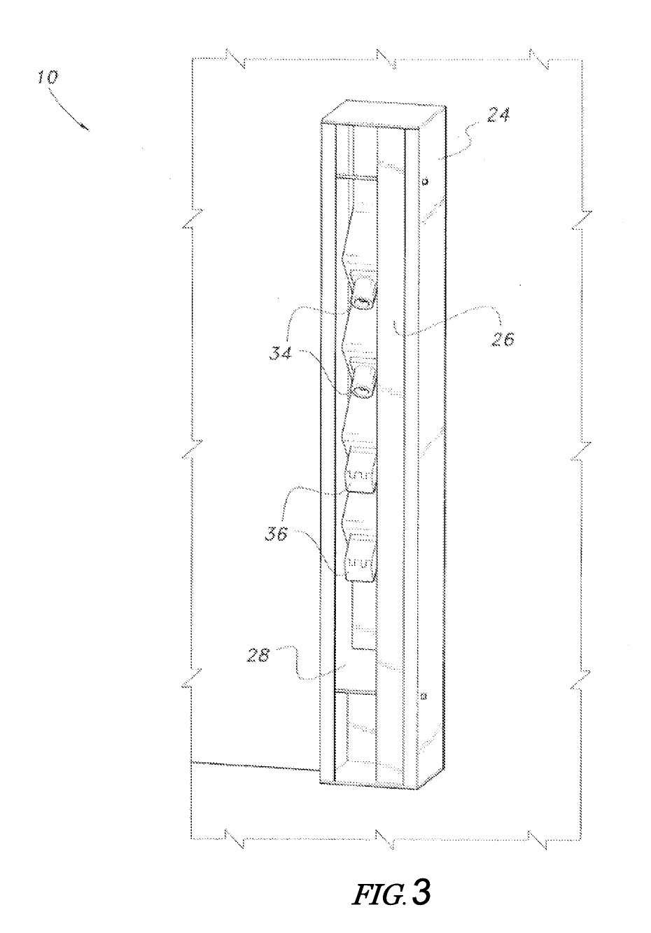

In FIG. 2 and FIG. 3 there is shown an embodiment of the dual source connector system 10 from the front of the unit. The system 10 includes a housing 24 having in this embodiment an open front area 28 that defines an open interior region of the device. Although shown in a rectangular configuration the shape is not a critical component and one skilled in the art could easily change the shape as desired and shown in other figures herein. The open interior region 28 of the housing 24 that comprises a blocking device in this embodiment, a panel 26. It also comprises first and second areas comprising first and second sets of electrical connectors. These areas can be lateral to each other or on top and bottom configurations, diagonal or positioned as desired.

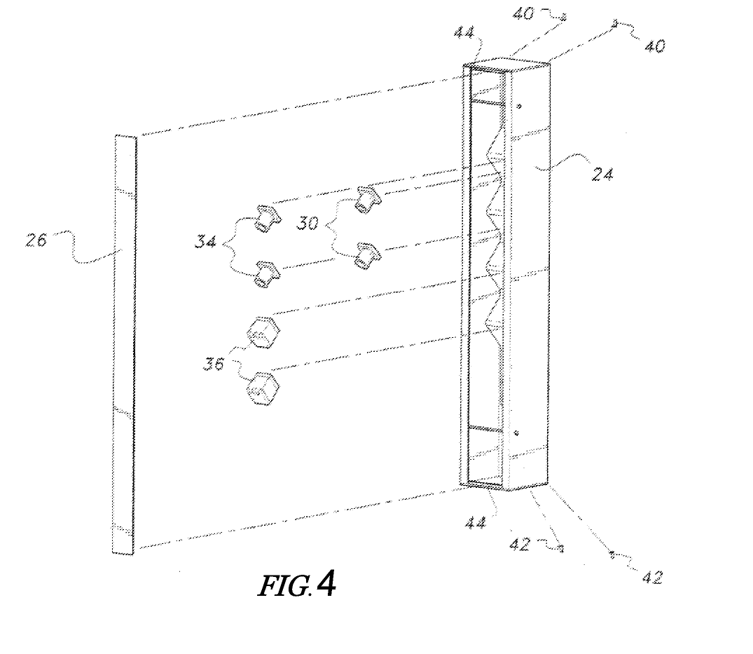

The housing 24 can have appropriate mounting brackets or tabs sufficient for mounting to a cabinet or to the permanent generator 12 and/or the automatic transfer switch 20, although one skilled in the art will understand that the housing 24 may be adapted for mounting (via mounting brackets or any other suitable means or support), on any suitable surface or may be a free standing unit as desired. As described above, the housing can be of any suitable material such as aluminum, sheet metal and in some embodiments is watertight to resist exposure to the elements. In other embodiments, it also has a front cover positioned over the face of the front of the housing. One skilled in the art could easily fashion a front cover in view of the disclosure. In FIG. 4, upper and lower mounting brackets 40 and 42 are shown as an embodiment of such mounting.

The first set of generator connectors includes connectors 34 adapted for connecting the phase lines of a portable generator 14 to the automatic transfer switch 20 and connectors 36 for connecting the portable generator to neutral and to ground busses. The buss in this embodiment is in the automatic Transfer Switch but can be anywhere in the system and one skilled in the art could so position the buss. The second set of generator connectors is adapted for connecting the phase lines of the permanent backup generator 12 to the automatic transfer switch 20. The upper two connectors 30 are connected to lugs or contacts of the transfer switch 20 (see back of unit in later figures for lug connectors). The interior of the housing has a pair of box fittings 31 mounted. Cables 32 extend through the box fittings 31, which are equipped with clamps or other form of strain relief, and are connected, to the phase lines of the permanent standby generator. The opposite ends of the cables 32 are equipped with connectors that mate with the second set of connectors 30 to electrically connect the permanent standby generator to the automatic transfer switch 20.

Although as described above, any suitable connectors may be utilized in the practice of the present invention, depending on the particular nature of the generators and electrical equipment being connected. The connectors 30 for connecting the permanent generator to the emergency lugs of the permanently mounted automatic transfer switch 20 may be, for example, the Series 16 male locking cam-type connectors manufactured by Cooper Crouse Hinds. These connectors receive corresponding Series 16 locking cam-type female connectors on cables 32 for connection to the phase lines of the permanent generator 12. The connectors provided for connection to the portable generator 14 may be, for example, Series 16 male locking cam-type connectors, also manufactured by Cooper Crouse Hinds. Appropriately sized openings are formed in an internal panel of housing 24 for receiving the rear portions of the connectors, and for connecting the connectors to the appropriate electrical connections of the automatic transfer switch 20, and to the neutral ground buss bars (or bus bars). Although, in the above embodiments, similar types of connectors are used on both sides of the system 10, it is preferable that dissimilar types of connectors be utilized to prevent accidental connections of the wrong generator cables or generator.

The first and second sets of connectors are in one embodiment, non-compatible and non-interchangeable, so that the permanent generator 12 and the portable generator 14 may not be cross-connected. Although shown as being vertically stacked, the connectors 30, 34, 36 may be arranged within the housing in any desired configuration or arrangement.

A blocking device, sliding door 26 is mounted within the open front end of the housing 24 to allow selective access, utilization and connection to only one of the first and second sets of generator connectors at a time. As shown in this embodiment, the sliding door 26 has a width about half the width of housing 24, thus allowing the door 26 to cover one set of connectors, while leaving the other set exposed at any given time. In FIG. 2, the sliding door 26 is slid to the left, exposing the second set of connectors 30 and 31. In this configuration, the pair of phase conductors of the permanent standby generator 12 are connected through system 10 to the site's service panel by cables 32. In FIG. 3, the door 26 is slid to the right, providing access to the first set of connectors 34 and 36.

In the shown configuration, the cables 32 and the connectors associated therewith, project beyond the path of the sliding cover 26 thus making it impossible for the permanent generator 12 to be connected with when the temporary generator 14 is being connected and the portable generator 14 may be connected through system 10. In FIG. 4, the door 26 is shown as being slidable on rods 44. It should be understood that any means for mounting the door, or other blocking devices, may be utilized. For example, sliding hinge mounting and the like are all contemplated in one embodiment and the inside surface of the door 26 may have a ground lug that can be connected to a ground by a cable such as a ribbon cable.

In utilizing the system 10 allows for selective connection to one of the two generators. In normal use, the permanent standby generator 12 is connected to an automatic transfer switch by attaching cables 32 to the connectors 30 in the right hand column. When it is desired to use a portable generator instead of the permanent standby generator, cables 32 are disconnected, door 26 is slid to the right, covering connectors 30 and exposing connectors 34 and 36, and the portable generator is attached to connectors 34 and 36 by use of appropriate connectors.

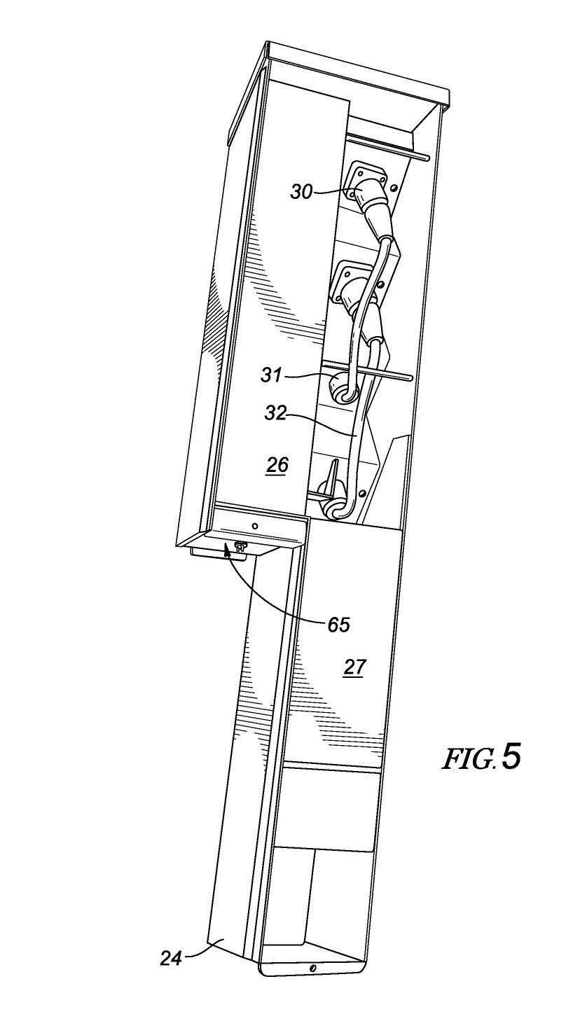

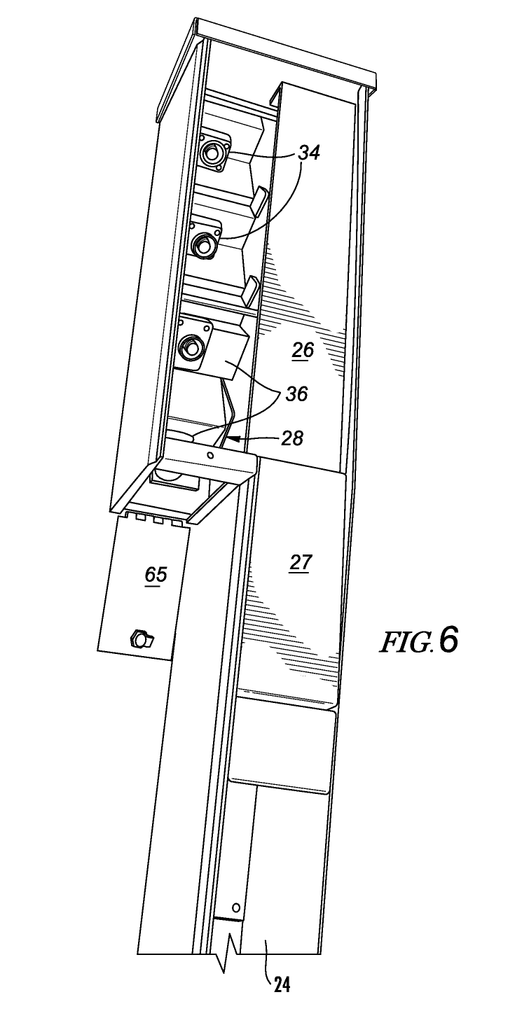

FIG. 5 and FIG. 6 show alternate embodiments of the present device. The numbering in this embodiment refers to the similar components in the previous figures. In this embodiment the housing 24 is not rectangular, rather having a short side and a long side. As described above the different shape is within the skill in the art. This embodiment shows a lower door 65 in closed position in FIG. 5 and open position in FIG. 6. The lower door 65 is designed to route cable from a temporary generator 14 from the bottom, so that running the cable can be a relatively weather resistant event. When not in use the door 65 is kept in a closed position. Note that a lever can be utilized or other device, to prevent the sliding door from accidently sliding unintendedly and thus, accidently exposing the wrong side during use. The sliding door 26 in this depiction is a two piece door where the upper portion 26 interlocks with the lower portion 27 when in the right blocking position depicted in FIG. 6.

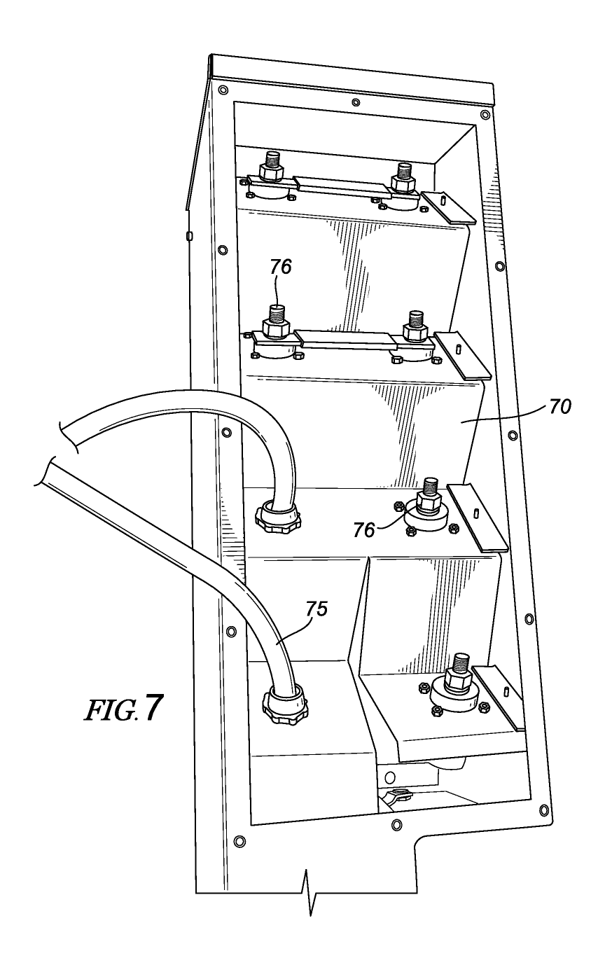

FIG. 7 depicts a view of the back side of the device of the present invention. In this embodiment cables from the permanent generator 75 are shown coming into the device. Lugs 76 for both the first and second generator connectors are shown for attaching cables to the automatic transfer switch. It is understood that rather than lugs, any other connection means, permanent or temporary, can be used to attach the generators using the device and this particular part of the invention is well within the skill in the art in view of this one embodiment.

The examples and figures are not intended to be limiting in any manner. Substitutions of material, connectors, blocking means and the like are within the scope of the invention in the claims which follow.

What is claimed is:

1. A dual electrical source connector system comprising:
a) a housing having an open front wherein the housing defines an open interior area and has a first interior region and a second interior region;
b) a first set of electrical source connectors positioned within the first region;
c) a second set of electrical source connectors positioned within the second region;
d) one or more blocking devices which physically allows no more than one set of electrical source connectors to be connected to an electrical source at a time.

2. A dual electrical source connector system according to claim 1 wherein the blocking device is a sliding door which is slidable so that it either selectively covers the first set or the second set of electrical source connectors.

3. A dual electrical source connector system according to claim 2 where the sliding door prevents use of either set of connectors by being so close to either set when it covers that set, that it prevents the connectors that are covered from being used.

4. A dual electrical source connector system according to claim 1 wherein the blocking device has a device to prevent the blocking device from accidently changing which set of electrical source connectors can be used.

5. A dual electrical source connector system according to claim 4 wherein the blocking device is a sliding door which can be locking into position over either the first or second set of connectors.

6. A dual electrical source connector system according to claim 1 which provides for a single phase electrical source to be connected to the device.

7. A dual electrical source connector system according to claim 1 which provides for a dual phase electrical source to be connected to the device.

8. A dual electrical source connector system according to claim 1 wherein the system is connected to an auto transfer switch for transferring a power load to either the first or second set of electrical source connectors.

9. A dual electrical source connector system according to claim 8 which is connected to an electrical power grid source for switching between the power grid and either a first or a second electrical power source.

10. A dual electrical source connector system according to claim 1 wherein the front has a means for closing the front with or without the first or second connectors connected.

11. A dual electrical source connector system according to claim 1 wherein the system is designed for a three phase electrical system.

12. A dual electrical source connector system according to claim 1 wherein the system is designed for a single phase system.

13. A dual electrical source connector system according to claim 1 wherein the blocking device is a two piece interlocking cover.

14. A dual electrical source connector system according to claim 1 wherein the blocking device is a single sliding cover.
